(19) United States
(12) Patent Application Publication
(10) Pub. No.: US 2026/0338035 A1
(43) Pub. Date: Oct. 29, 2026

(54) MANEUVERABLE & RETRACTABLE AQUATIC LADDER

(71) Applicant: Matthew Houser, Woodstock, GA (US)

(72) Inventor: Matthew Houser, Woodstock, GA (US)

(21) Appl. No.: 19/074,358

(22) Filed: Mar. 8, 2025

(51) Int. Cl. E06C 9/08; B63B 27/14

(52) U.S. Cl. CPC E06C 9/08; B63B 27/146

(57) ABSTRACT

An aquatic ladder is constructed with a left upper rail and a right upper rail, a left lower rail and a right lower rail, all four rails mutually parallel to each other and spaced apart symmetrically. A plurality of perforated steps are spaced apart, oriented horizontally, and permanently affixed to the inner surfaces of the four rails. The left and right lower rails, by means of co-planar bends, transition into left and right posts, and left and right handles, respectively, at the upper structure of the aquatic ladder. A left stabilizer bar orthogonally connects to the structure of the left handle and a right stabilizer bar connects to the right handle, each providing stability and rigidity to the respective handles. A pull-arm tube is removably affixed proximate the left upper rail and is operated as a lever when necessary to withdraw the aquatic ladder from its submersion in water.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The field of the disclosed inventive concept relates generally to methods and equipment utilized as an “aquatic, or marine ladder.” In marine environments, this type of device is frequently necessary for persons who must engage in boarding a boat or disembarking from a boat to a dock or landing type structure. This type of ladder is useful for both recreational and business/commercial boating

The term “aquatic ladder” generally includes those ladders which are designed and constructed for use when an individual partially submerges the ladder into a body of water. The primary purpose of such ladders is to facilitate ease and convenience of use, whether climbing/descending to/from a dock of similar structure. In addition, storage of the aquatic ladder, particularly upon a boat, is a consideration.

Normally, most ladders designed for such use comprise relatively short dimensions and may be used for ingress and/or egress from both fixed and floating docks. For instance, previous designs have comparatively few rungs or flat sequential steps extending into the water. Many of these previous devices have included structures enabling them to be compact for storage, and features such as hinges for folding and/or sliding extensions. Often, these types of ladders are constructed with parallel sides made of chain or rope, which also permits them to be stored in small spaces.

Most of the earlier aquatic ladders have also included rungs which may be somewhat narrow, or round, making them even more uncomfortable and difficult to use. Due to the flexible and unpredictable movement of some earlier aquatic ladders, as a user attempted to climb them or descend onto a boat by using them, a secure handhold was unavailable, particularly above the water level. Storage space for an aquatic ladder is limited, and therefore, may be a problem on boats.

One of the objects of the inventive device disclosed is to make more practical boarding and disembarking while a user may also be carrying items such as pets, water skis, or aquatic gear. Further, the disclosed aquatic ladder is constructed with the aim of being more user friendly for elderly persons and possibly, some disabled persons.

### (2) Description of the Related Art, Including Information Disclosed Under 37 CFR 1.97 and 1.98

U.S. Published Patent Application #2019/0039694 A1; Feb 2019; Howie, Mark

A marine ladder includes a base and a stair assembly connected to the base. The stair assembly includes four telescoping assemblies, each having an outermost member and one or more telescoping members telescopingly extendable therefrom. A step is connected between the respective outermost members of the four telescoping assemblies.

Further steps are connected between respective telescoping members of the four telescoping assemblies.

U.S. Pat. No. 8,720,643 B1; 13 May 2014; Adair, Michael Ray;

The aquatic ladder has wide, deep treads, arranged like a staircase, with side and upper railings to make it easy to enter or exit the water, even by elderly people, tired individuals, those carrying aquatic equipment, such as SCUBA gear or water skis, and, even, by pets. The ladder is preferably made from aluminum, although it can be made of other materials, such as steel (e.g., stainless or galvanized), fiberglass, plastic, or other composites.

U.S. Pat. No. 6,368,654 B1; 30 Apr. 2002; Ziaylek, Theodore

A ladder attached to a generally vertically extending wall or surface which is particularly useful when attached to the side of vehicles which can pivot outwardly to a slight extent at the bottom area thereof in order to increase the climbing inclination to make it easier to climb vertically for emergency personnel under emergency situations and especially when carrying heavy equipment or other necessary emergency apparatus. The ladder configuration is pivotal between a storage position extending generally vertically next to the wall and a deployed position or extended position set at the inclination angle to facilitate climbing thereof. A resilient locking device can secure the ladder in the collapsed position and a pivotally movable scissors assembly controls movement of the lower portion of the ladder between the inclined position and the vertical position.

### BRIEF SUMMARY OF THE INVENTIVE CONCEPT

The disclosed inventive concept, an aquatic ladder 1, has, as its principal objectives, ease of deployment into and out of a body of water, physical access and mounting by a user, and ease of storage. In order to accomplish these objectives, the aquatic ladder 1 includes features facilitating its use by a wide range of individuals, including elderly persons, children, persons with disabilities or carrying marine-related gear. Further, the aquatic ladder 1 may be used by pets, such as dogs, as its perforated steps 53-56, provide sure-footed contact during ingress and egress from, the water, a boat, or a landing/dock 15 area.

In order to accomplish its design and operational objectives, the aquatic ladder 1 is constructed with a pairing of a left upper rail 20 and a left lower rail 22, and a second pairing of a right upper rail 22 and a right lower rail 23. Both pairings of rails are arranged mutually parallel to each other. In the ultimate assembly of the aquatic ladder 1, the plane of the pairing of left upper rail and left lower rail and the plane of the pairing of the right upper rail and right lower rail are positioned, spaced apart and correspondingly facing each other. Further, a left lower rail 22 and a right lower rail 23 serve to provide guidance and stability enhanced by hand contact with the upper rails 20, 21, as necessary.

The left lower rail 22 has an essentially tubular cross-section and at its first end, transitions, by means of a slight bend, into a left post 30 structure. Similarly, the right lower rail 23 has an essentially tubular cross-section, transitioning at its first end into a right post 31 structure. A plurality of rectangular, perforated steps 53, 54, 55, 56, are oriented horizontally, spaced apart at regular vertical intervals, and rigidly connected to the inner surfaces of the left upper and lower rails 20, 22, and the right upper and lower rails 21, 23.

The previously mentioned left post 30 structure further transitions, co-planarly, to sequentially form a left front arc 32(a), a left handle 32, a left rear arc 32(b), and a right beam 32(c). Similarly, the right post 31 is bent to co-planarly form a right front arc 33(a), a right handle 33, a right rear arc 33(b), and a co-planar right beam 33(c).

A left stabilizer bar 34 orthogonally connects the left beam 32(c) and the left post 30, providing co-planar rigidity to the left handle 32. A right stabilizer bar 35 connects the right beam 33(c) and the right post 31, thereby providing co-planar rigidity to the right handle 33, when grasped by a user.

In the preferred embodiment, a grouping of four rectangular, perforated steps 53, 54, 55, 56, are symmetrically spaced apart, each one placed in sequence, horizontally, between the inner planes of the two pairings of rails. The steps 53, 54, 55, 56 oriented substantially horizontally are rigidly connected, at their respective corners, to the inner surfaces of the left upper and lower rails 20, 22, and the right upper and lower rails 21, 23. In the preferred embodiment, the steps 53, 54, 55, 56 are welded to the inner surfaces of the left upper and lower rails 20, 22.

For providing retractability and maneuverability of the aquatic ladder 1, a hollow pull-arm tube 40 is oriented substantially parallel to the left upper rail 20. The pull-arm tube 40 is rigidly attached at its lower end to the left end of the bottom step 53. The upper end of the pull-arm tube 40 is pivotally attached, by means of a brace 6 apparatus, to a pull-arm handle 42. A user may withdraw the aquatic ladder 1 from a condition of abutting a dock or boat, or from a condition of submersion in water by grasping the integral pull-arm handle 42, and re-positioning the aquatic ladder 1 onto a boat 16 interior, landing, or dock structure 15.

### BRIEF DESCRIPTION OF THE VIEWS OF DRAWINGS, AS EXEMPLARY EMBODIMENTS OF THE INVENTIVE CONCEPT

FIG. 1 presents a perspective view of the aquatic ladder 1, illustrating the left and right upper rails 20, 21, left and right lower rails 22, 23, four perforated steps 53-56, and left and right handles 32, 33.

FIG. 2 is a view of the left side of the aquatic ladder 1.

FIG. 3 displays a closeup view of the bottom step 53, further displaying a pull-tube connector 43, which connects the lower end of the left upper rail 20 to the pull-arm tube 40.

FIG. 4 is a side view of the upper end of the pull-arm tube 40, the location of the pull-arm plate 41, and an assembly 4 attaching the upper pull-arm tube 40 to the front left arc 32(a).

FIG. 4A presents a cross-sectional view of the elliptical opening 40(a) of the opening of the upper end of the pull-arm tube 40.

FIG. 5 presents a close-up, downward looking view of the pull-arm handle 42, its pull-arm plate 41, the pull-arm plate 41 being attached within the pull-arm tube 40.

FIG. 6 shows a perspective view of the mounting assembly 3, further displaying the saddle 5, L-bracket 4, and brace 6.

FIG. 7 is a plan view of the mounting assembly 3, including the L-bracket 4, brace 6, and saddle 5.

FIG. 8 is a profile view of the mounting assembly 3.

FIG. 9 displays a side view of the assembly 5 of FIG. 6.

FIG. 10 is a perspective view of the pull arm handle 42, cuff 44, and the pull-arm plate 41.

FIG. 11 is a planar view of the inner gripping area of the pull-arm handle 42 and the position of the pull-arm plate 41.

FIG. 12 is a side view of the cuff 44 and pull-arm plate 41, and interior of the pull-arm handle 42.

FIG. 13 illustrates the aquatic ladder 1 in the process of being lifted upward, by a user 2 having grasped the pull-arm handle 42 and pulling the bottom step 53 upwards from its submerged condition in a body of water 14.

Table of Nomenclature & Part Numbers of the Inventive Concept

| | | | |
|---|---|---|---|
| 1. | Aquatic ladder | 33(a) | Right front arc |
| 2. | User | 33(b) | Right rear arc |
| 3. | Mounting assembly | 33(c) | Right beam |
| 4. | L-Bracket | 34. | Left stabilizer bar |
| 5. | Saddle | 35. | Right stabilizer bar |
| 6. | Brace | 36.-39. | n/a |
| 7.-9. | n/a | 40. | Pull-arm tube |
| 10.-13. | n/a | 40(a) | Elliptical opening |
| 14. | Water | 41. | Pull-arm plate |
| 15. | Dock | 42. | Pull arm handle |
| 16. | Boat | 43. | Tube connector |
| 17. | Edge | 44. | Cuff |
| 18. | Dock mount | 45. | Pivotal orifice |
| 19. | n/a | 46.-49. | n/a |
| 20. | Left upper rail | 50.-52. | n/a |
| 21. | Right upper rail | 53. | Bottom step |
| 21(a) | Right bend | 54. | Second step |
| 22. | Left lower rail | 55. | Third step |
| 22(a) | Left bend | 56. | Upper step |
| 23. | Right lower rail | 57. | Perforations |
| 24. | Left rail joinder | 58.-59. | n/a |
| 25. | Right rail joinder | 60. | Tube bolt |
| 26.-29. | n/a | 60(a) | Lower bolt |
| 30. | Left post | 60(b) | Lower bolt |
| 31. | Right post | 61. | Pivotal bolt B |
| 32. | Left handle | 62. | Mounting bolt C |
| 32(a) | Left front arc | 62(a) | (b) |
| 32(b) | Left rear arc | 62(c) | Retaining bolt |
| 32(c) | Left beam | 63. | Bolt D |
| 33. | Right handle | 64. | Bolt E |

### DETAILED DESCRIPTION OF THE INVENTION

The objects, features, and advantages of the inventive concept presented in this application are more readily understood when referring to the accompanying drawings. The drawings, totaling thirteen figures, show the basic components and functions of embodiments and/or methods of use. In the several figures, like reference numbers are used in each figure to correspond to the same component as may be depicted in other figures.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The characterizations of various components and orientations described herein as being “vertical”, “horizontal”, “upright”, “right”, “left”, “side”, “top”, or “bottom” designate directions in the drawings to which reference is made and are relative characterizations only based upon the particular position or orientation of a given component of the aquatic ladder 1, as illustrated. The terms, “left” and “right” are referenced with respect to a user's left and right hands when facing inward while using the aquatic ladder 1 These terms shall not be regarded as limiting the invention. The words “downward” and “upward” refer to position in a vertical direction relative to a geometric center of the apparatus of the present invention and/or designated parts thereof. The terminology includes the words above specifically mentioned, derivatives thereof and words of similar import.

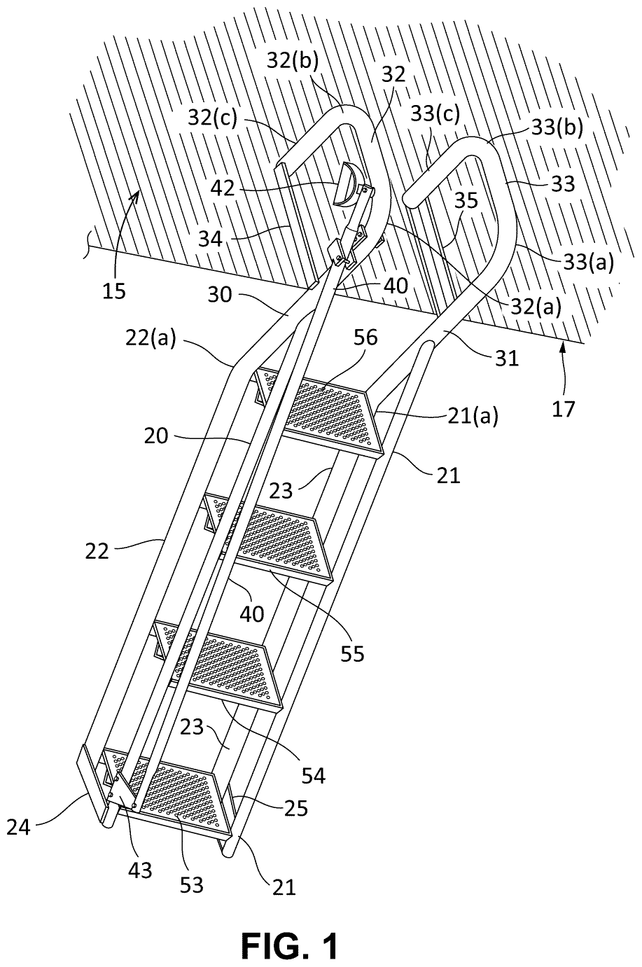

The discussion of the present inventive concept will be initiated with FIG. 1. In FIG. 1 there is illustrated a perspective view of the aquatic ladder 1 having been positioned atop the waterside, outer edge 17 of a deck 15 or similar structure. The principal components of the aquatic ladder 1 are shown to be a left upper rail 20 and a right upper rail 21, each mutually parallel to the other. The left upper rail 20 and right upper rail 21 serve to provide guidance and stability as enhanced by a user's hand in contact with the upper rails 20, 21, as necessary. Further shown are a left lower rail 22 and a right lower rail 23, being mutually parallel to their corresponding upper rail 20, 21. The upper and lower rails 20, 21, 22, 23 are constructed as hollow tubes of stainless steel, or other rigid water-resistant material.

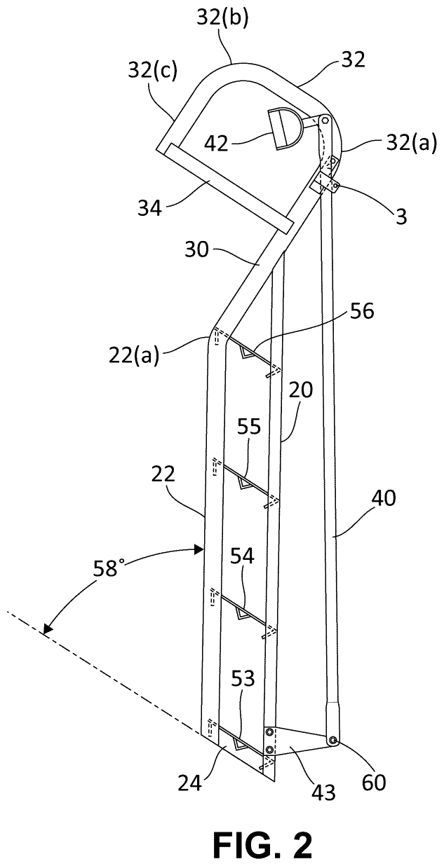

FIG. 2 is a right-side view of the aquatic ladder 1. It is seen in FIG. 2 that the first, or upper, end of the left lower rail 22 is constructed having an upwardly directed bend 22(a) of 58 degrees, which transitions into a left post 30. Likewise, in FIG. 1, the first, or upper end of the right lower rail 23 is constructed also having an upwardly directed bend 23(a) of 58 degrees, transitioning into a right post 31.

Again, referring to FIG. 2, it is seen that the left post 30 co-planarly forms other structural members, specifically a front left arc 32(a), a co-planar left handle 32, a left rear arc 32(b), and a co-planar left beam 32(c). In FIG. 2 there is shown the right post 31 co-planarly forms a front right arc 33(a), a right handle 33, a right rear arc 33(b), and a co-planar right beam 33(c). Both the left post 30 and right post 31 thereby form inverted U-shaped handles.

As shown in FIG. 1 and FIG. 2, a left stabilizer bar 34 is connected to both the left beam 32(c) and the left post 30, providing co-planar rigidity to the left handle 32. A right stabilizer bar 35 connects the right beam 33(c) and the right post 31, thereby providing co-planar rigidity and stability to the right handle 33, when the right handle 33 is grasped by a user

In reference to FIG. 1, it is to be noted that the left lower rail 22 has an essentially tubular cross-section and at its first, or upper, end transitions, by means of a slight bend 22(a), into a left post 30 structure. Similarly, the right lower rail 23 of tubular cross-section, at its first, or upper, end transitions, by means of a slight bend 23(a) into a right post 31 structure.

A grouping of four rectangular, perforated steps 53, 54, 55, 56, are symmetrically spaced apart, each step oriented substantially horizontal and rigidly connected to the inner surfaces of the left upper and lower rails 20, 22, and the right upper and lower rails 21, 23. For reference purposes, both the left upper rail 20 and right upper rail 21 are deemed to be oriented at the “forward” or frontal portion of the aquatic ladder 1.

Viewing FIG. 1, it is shown that each step 53, 54, 55, 56, at its leftmost rearward corner, is permanently attached to the inner surface of the left lower rail 22, and at its leftmost forward corner, is permanently attached to the inner surface of the left upper rail 20, respectively. Similarly, each of the four perforated steps 53, 54, 55, 56, is also permanently attached, at its right rearward corner, to the inner surface of the lower rail 23 and at its rightmost forward corner, to the inner surface of the right upper rail 21, respectively.

It is to be noted that each of the steps 53, 54, 55, 56 is constructed with a plurality of perforations 57. This feature assists in decreasing the effect of poundage per square inch, or the weight of water overlaying each submerged step 53, 54, 55, 56, upon a user 2 withdrawing the aquatic ladder 1 from a body of water, or from abutment against a dock 15 or boat landing structure.

The left and right upper rails 20, 21 and the left and right lower rails 22, 23 are mutually parallel to each other. Further the left and right upper rails and lower rails 20, 21, 22, 23 are substantially vertical members which extend down toward, or into, the water. The upper portions of the left and right upper rails and lower rails 20, 21, 22, 23 are designed so as to contact the hull of a boat or the sidewall of the dock 15 or boat landing area at which the aquatic ladder 1 is being used.

For further clarification, the term “substantially vertical” is applied in this disclosure, even though the mutually parallel left and right upper rails and lower rails 20, 21, 22, 23 may be sloping, as opposed to precisely vertical in a particular circumstance. However, the connecting left post 30 and right post 31 are arranged such that both posts 30, 31 are substantially vertical when positioned to correspond to the waterside edge of, for instance, a dock 15. Referring to a converse situation, if the aquatic ladder 1 is attached to the hull or transom of a boat 16 which has a sloped hull, the orientation of the aquatic ladder 1 again may not be precisely vertical.

In general terms, utilization of the aquatic ladder 1 occurs when a user positions the aquatic ladder 1 substantially vertically, enabling the user to access its self-contained steps 53, 54, 55, 56. It is desirable to have the substantially vertical support members (left and right upper rails and lower rails 20, 21, 22, 23) lie proximate a wall of the structure to be boarded (e.g., the boat or dock). This assists a user in compensating for relative movement between the aquatic ladder 1 and object(s) to which it is in contact nearby. Correspondingly, the steps 53, 54, 55, 56, with normal use of the aquatic ladder 1, are oriented substantially horizontal relative to the boat, deck, or other object to be transited, which enhances the stability of the aquatic ladder 1.

In accordance with operational aspects of the invention, the upper portions of the substantially vertical left and right upper and lower rails 20, 21, 22, 23 extend out of the water, onto, and above the surface of the boat 16, dock 15 or other structure to be accessed.

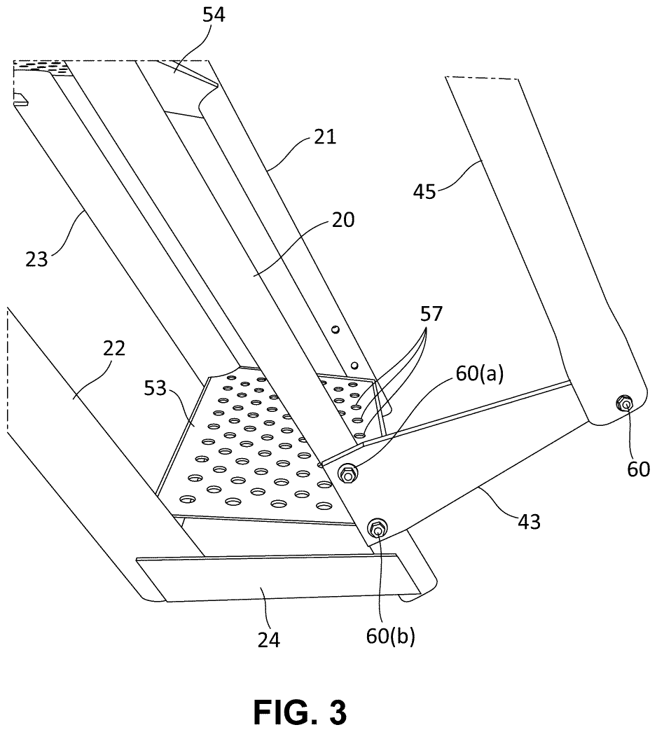

For providing retractability and maneuverability of the aquatic ladder 1, a separable, hollow pull-arm tube 40, containing an internal pull-arm plate 41 and pull-arm handle 42, is positioned substantially parallel to, and directly above, the left upper rail 20. FIG. 3 displays the manner in which the lower end of the pull-arm tube 40 is attached to the structure of the aquatic ladder 1. A rigid tube connector 43 is affixed, at its rearward end, by two lower bolts B 60(a), 60(b) which provide attachment to the bottommost end of the left upper rail 20. The frontward end of the tube connector 43 is attached, by one upper bolt A 60, to the lowermost end of the pull-arm tube 40.

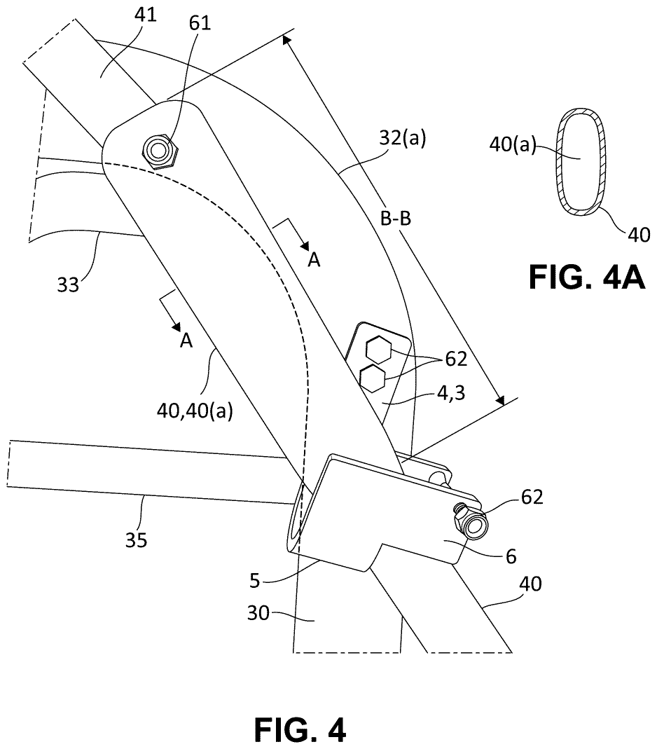

FIG. 4 illustrates the upper end of the pull-arm tube 40 and its internally contained pull-arm plate 41. It is to be noted that approximately 8.0 inches [B-B] of the upper end of the pull-arm tube 40 are compressed slightly inward, causing the formation of an elliptical shaped cross-sectional opening at the uppermost end. In this manner, a portion of a rectangular cross-sectioned pull-arm plate 41 may be accommodated within the pull-arm tube 40.

Further shown in FIG. 4 is a pivotal bolt B 61 which serves (1) to connect the upper end of the pull-arm tube 40 to the left front arc 32(a) of the aquatic ladder 1 and (2) as an axis about which the pull-arm plate 41 may be rotated by a user when maneuvering the aquatic ladder 1. The pull-arm tube 40 is affixed to the left front arc 32(a) by means of a mounting assembly 3 comprising an L-Bracket 4, saddle 5, and a brace 6.

Two mounting bolts C 62 affix the L-bracket 4 to the inner surface of the left front arc 32(a). This arrangement provides support of the pull-arm tube 40 within the saddle 5 of the assembly 3. A retaining bolt 62(c) extends through the mounting assembly 3 and serves to confine the upper end of the pull-arm tube 40 within the mounting assembly 3. In practical use, the retaining bolt 62(c) may be temporarily removed.

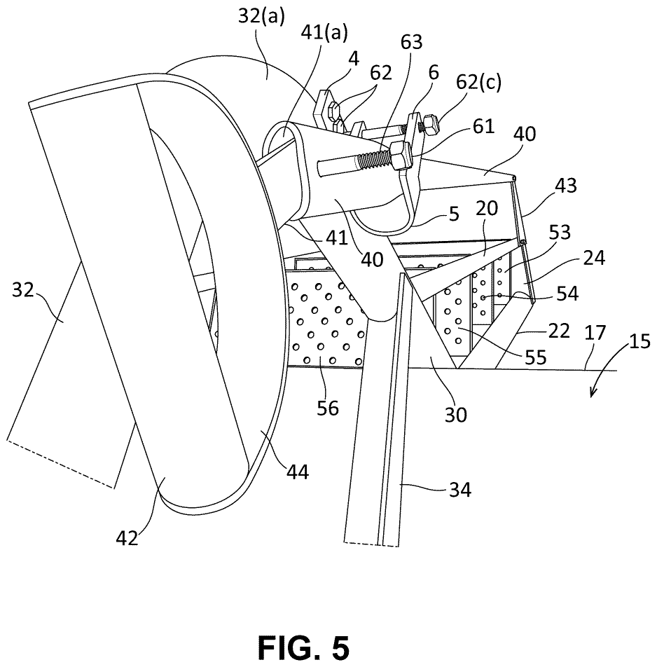

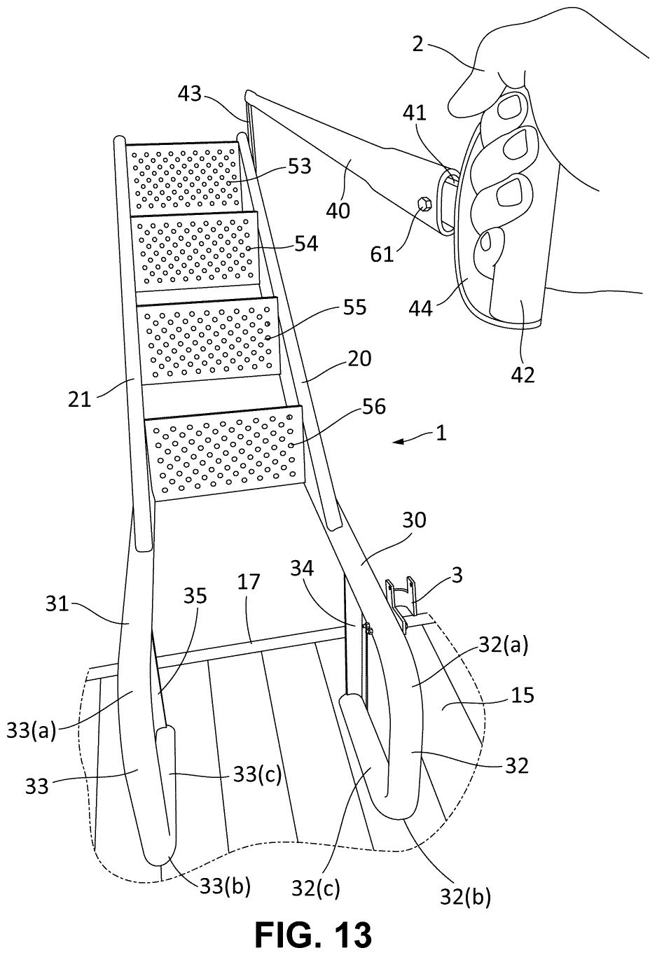

The angle of the pull-arm tube 40 relative to the left upper rail may then be re-positioned and changed significantly, allowing a user to operate the pull-arm tube 40 in the manner of a moveable lever. In that manner, the tube connector 43 (more clearly seen in FIG. 3) is engaged to function as a lever and fulcrum for operation of the pull-arm tube 40. This arrangement facilitates up-lifting of the entire aquatic ladder 1 from its position, for instance, against a dock 15. This function of the aquatic ladder 1 is more clearly understood by referring to FIG. 5 and FIG. 13.

FIG. 5 illustrates a close-up, downward looking view of the pull-arm handle 42, its pull-arm plate 41 extending into the interior of the elliptical opening 40(a) of the pull-arm tube 40. FIG. 4A presents a cross-sectional view of the elliptical opening 40(a) of the upper end of the pull-arm tube 40, as viewed from the orientation of section line A-A of FIG. 4.

Also shown in FIG. 5 are the mounting assembly 3 components are disclosed as a saddle 5, brace 6, and L-Bracket 4. A user, as necessary to retract or withdraw the aquatic ladder 1 from a state of partial submersion in water and onto to a landing or dock structure 15, may disengage a retaining bolt 62(c) which then frees the pull-arm tube 40 for upward movement, separable from its close proximity to the left upper rail 20. The pull-arm handle 42 is then freed to uplift the bottommost segment of the aquatic ladder 1 from immersion in water or its position of abutment against a dock 15.

As is shown in FIG. 5, a user, upon grasping the pull-arm handle 42, may slightly maneuver the pull-arm plate 41 up-and-down vertically. In this manner, the pull-arm tube 40 acts as a lever, using as a fulcrum the structure against which the uppermost section of the aquatic ladder 1 abuts.

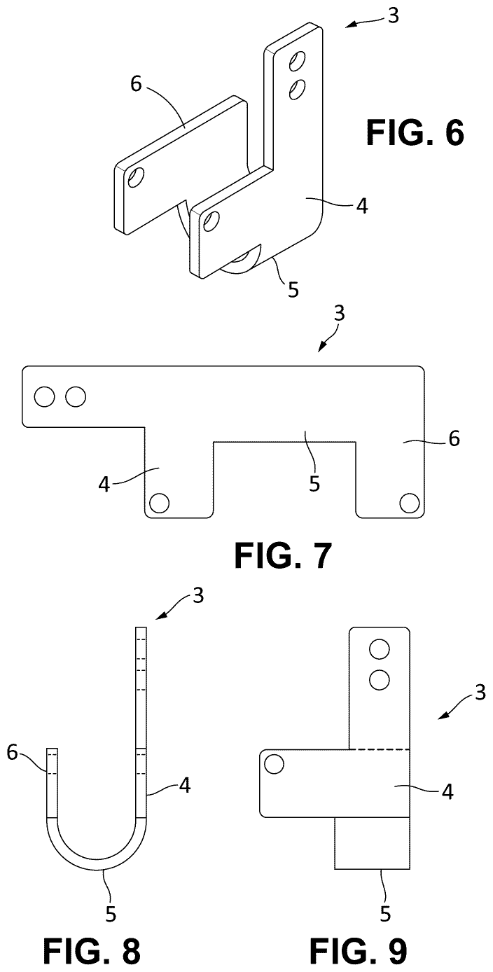

FIG. 6, FIG. 7, FIG. 8, and FIG. 9 illustrate various views of the mounting assembly 3, which is essential to efficient operation of the aquatic ladder 1. FIG. 6 is a perspective rendering of the stand-alone mounting assembly 3. FIG. 7 depicts a plan view of the mounting assembly 3, including the L-bracket 4, brace 6, and saddle 5. FIG. 8 is a profile view of the mounting assembly 3. FIG. 9 displays an inner-oriented side view of the mounting assembly 5 of FIG. 8.

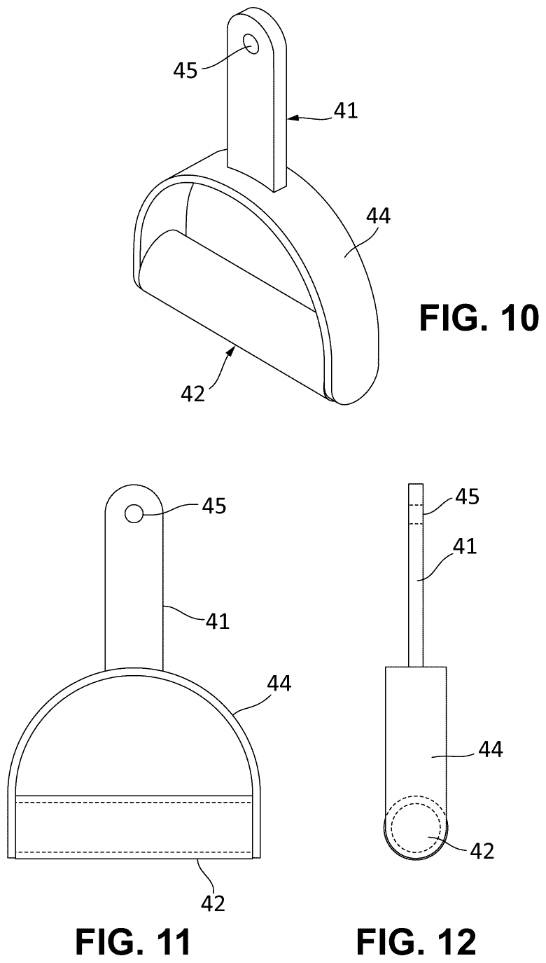

FIG. 10 gives a perspective view of the entirety of the pulling mechanism of the aquatic ladder 1, being the pull arm handle 42, cuff 44, and the pull-arm plate 41. The pull-arm plate 41 further illustrates a pivotal orifice 45 which allows a user to rotate the pull handle 42 about the pivotal bolt 61 at the elliptical opening 40(a) of the pivot-arm tube 40.

FIG. 11 is a planar view of the inner gripping area of the pull-arm handle 42 and the relative position of the pull-arm plate 41. FIG. 12 displays a side view of the cuff 44 and pull-arm plate 41, and interior of the pull-arm handle 42.

FIG. 13 illustrates the aquatic ladder 1 in the process of being lifted upward, by a user 2 having grasped the pull-arm handle 42 and pulling the bottom step 53 upwards from its submerged condition in a body of water. To accomplish this maneuver, the user 2 has undone the retaining bolt 62(c) (not in view), which frees the pull-arm tube 40 to be lifted and pivoted about the lower bolt A attached to the tube connector 43.

The aquatic ladder 1 may then be positioned in an inverted orientation and placed at temporary placement atop the dock 15. The aquatic ladder 1 will make contact with the deck 15 at the points of its left and right handles 32, 33 immediately upon being pulled from the water 14. For display purposes, the aquatic ladder 1 may be supported by a temporary deck mount 18 proximate the edge 17 of the dock 15.

In order for the aquatic ladder 1 to function effectively, the upper structural components forming the left handle 32 and right handle 33 and the left post 30 and right post 31, respectively, contact the hull/transom of a boat or the flooring and side wall of a dock 15. These substantially inverted U-shaped handles 32, 33, provide hand support to make convenient the use of the aquatic ladder 1.

While preferred embodiments of the present inventive method have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, as described by the scope of the claims presented herein.

What is claimed is:

1. a maneuverable, retractable aquatic ladder, comprising:
(a) a pairing of a left upper rail and a left lower rail, each having a first end and a second end, both rails parallel to each other, spaced apart and connected at their second ends to a left rail joinder; a pairing of a right upper rail and a right lower rail, each having a first end and a second end, both rails parallel to each other, spaced apart and connected at their second ends to a right rail joinder;
(b) the first end of the left lower rail bent to form a left post, enabling the first end of the left upper rail to intersect and attach to the left post;
(c) the first end of the right lower rail bent to form a right post, enabling the first end of the right upper rail to intersect and attach to the right post;
(d) the respective left and right posts, by means of two consecutive co-planar arcs, form respective left and right handles;
(e) the plane of the pairing of left upper rail and left lower rail and the plane of the pairing of the right upper rail and right lower rail are positioned, correspondingly facing each other, whereby a plurality of perforated steps is orthogonally attached to the inner-facing surfaces of the left and right rail pairings; and
(f) a pull-arm tube having an upper end separably attached to the left post and having a lower end connected to the second end of the left upper rail.

2. The aquatic ladder of claim 1, wherein (a) the upper end of the pull-arm tube is removably attached, by means of a mounting assembly, to the left post; (b) upper end of the pull-arm tube further comprises a pull handle; and (c) the lower end of the pull-arm tube is pivotally connected to the second end of the left upper rail by means of a tube connector.

3. a maneuverable, retractable aquatic ladder, comprising:
(a) a pairing of a left upper rail and a left lower rail, each having a first end and a second end, both rails parallel to each other, spaced apart, and connected at their second ends to a left rail joinder; a pairing of a right upper rail and a right lower rail, each having a first end and a second end, both rails parallel to each other, spaced apart, and connected at their second ends to a right rail joinder;
(b) the first end of the left lower rail bent to form a left post, wherein the first end of the left upper rail intersects and attaches to the left post;
(c) the first end of the right lower rail bent to form a right post, wherein the first end of the right upper rail intersects and attaches to the right post;
(d) the left post, by means of two consecutive co-planar arcs, forming an inverted U-shaped left handle;
(e) the right post, by means of two consecutive co-planar arcs, forming an inverted U-shaped right handle;
(f) the plane of the pairing of left upper rail and left lower rail and the plane of the pairing of the right upper rail and right lower rail positioned correspondingly facing each other, with all upper and lower rails mutually parallel;
(g) a plurality of perforated steps orthogonally attached to the inner-facing surfaces of the left and right rail pairings; and
(h) a pull-arm tube having an upper end and a lower end, with (i) the upper end removably attached to the left post and (ii) the lower end pivotably attached to the second end of the left upper rail.

4. The aquatic ladder of claim 3, wherein (a) the upper end of the pull-arm tube is constructed with an integral pull handle; (b) the upper end of the pull-arm tube is removably attached, by means of a mounting assembly, to the left post; and (c) the lower end of the pull-arm tube is pivotally attached, by a tube connector, to the second end of the left upper rail, thereby enabling a user to maneuver the pull-arm tube in the manner of a lever to retract the aquatic ladder.

5. An improvement to an aquatic ladder of the type utilized to enable users of the ladder to transition to or from a body of water, the exterior of a boat, a dock, or boat landing, the ladder comprising at least one vertically sloping left rail and at least one vertically sloping right rail, each rail having a first, or upper, end and a second, or lower, end; the rails being mutually parallel and serving as handholds; and further, the ladder having a plurality of substantially horizontal steps attached between the rails, the improvement comprising:
(a) a pull-arm tube having an upper end and a lower end, with (i) the upper end of the pull-arm tube removably attached proximate the first end of at least one of the rails of the ladder; (ii) the upper end of the pull-arm tube further having an integral pull-handle; and (iii) the lower end of the pull-arm tube pivotally attached to the second end of at least one of the rails; thereby
(b) enabling a user to detach the upper end of the pull-arm tube and maneuver the pull-arm handle to pivotally rotate the second end of the corresponding rail and maneuver the lower end of the rail, retracting the aquatic ladder.

6. The aquatic ladder of claim 5, wherein (a) the upper end of the pull-arm tube is removably attached, by means of a mounting assembly, to the left post; and (b) the lower end of the pull-arm tube is pivotally attached, by a tube connector, to the second end of the at least one of the vertically sloping rails; thus enabling a user to maneuver the pull-arm tube in the manner of a lever and fulcrum to retract the aquatic ladder.
